(19) United States
(12) Patent Application Publication
(10) Pub. No.: US 2017/0245326 A1
(43) Pub. Date: Aug. 24, 2017

(54) Multilayer Structure for the Production of a Heating Floor or Wall Covering

(71) Applicant: GERFLOR, Villeurbanne (FR)

(72) Inventors: Alain Rivat, Les Sauvages (FR); Olivier Ceysson, Bollene (FR)

(21) Appl. No.: 15/435,897

(22) Filed: Feb. 17, 2017

(30) Foreign Application Priority Data
Feb. 19, 2016 (FR) 1651350

(51) Int. Cl. H05B 3/36; D06N 3/04; E04F 15/02; D06M 11/74; H05B 3/14; E04F 13/074; D06N 3/00; D06N 3/06

(52) U.S. Cl. CPC H05B 3/36; D06N 3/0011; D06N 3/042; D06N 3/045; D06N 3/06; D06M 11/74; H05B 3/145; E04F 13/074; E04F 15/02; D06N 2201/082; D06N 2203/048; D06N 2203/041; D06N 2203/042; D06N 2209/041; D06M 2101/00

(57) ABSTRACT

A multilayer structure for the production of a heating floor or wall covering or similar includes a decorative layer made up of at least one plastic surface layer. The decorative layer is bonded onto a heating layer, which heating layer is bonded onto a sublayer intended to be installed on the floor or a wall or the like. The heating layer is made up of a conductive band comprising conductive particles homogeneously distributed over the surface and/or in the thickness of said conductive band, which supports at least three conductive electrodes spaced from one another so as to define a discontinuous heating surface.

### TECHNICAL FIELD

The present disclosure relates to a heating multilayer structure, in particular for producing a heating floor or wall covering. The multilayer structure according to the disclosure can have the shape of a coiled band or the shape of a panel, slab, strip or the like.

The disclosed embodiments have an advantageous application in the production of a heating floor or wall covering, i.e. incorporating elements with which to heat the room or office in which it is installed using electric energy.

More generally, the disclosed embodiments have an advantageous application in the production of a flexible, heterogeneous multilayer structure which comes in a roll with which to heat a room or building by resistive heating.

### BACKGROUND

A multilayer structure for producing a floor covering is known from the art. This multilayer structure includes, generally, an upper decorative and surface layer, whose main functions are wear resistance, ease of cleaning and decorative appearance, bonded onto a backing sublayer intended to be bonded to the floor or the like.

These multilayer structures are commonly installed on a concrete slab, subflooring or sealant in which the heating functions are embedded. In particular, this is the case for circulating-water floor-heating systems. The disadvantage of these systems integrated into the floor is that they are difficult to repair because they are by definition inaccessible and hard to install in case of renovations of existing housing or rooms.

Multilayer structures for implementing floor covering can also be used in combination with a recessed heating sublayer incorporating a function of heating by conducting electrodes or by circulating water. During implementation, the heating sublayer is thus installed on the support, such as subflooring or screed. The floor covering is then laid floating on the heating sublayer or bonded in place using acrylic or even laid in adhesive.

The disadvantage of these recessed heating sub-layers is having multiple installation operations for a single surface. These operations are even more complex when they require cutting and adjustments both for the heating sublayer and for the floor covering.

Also, depending on the number and thickness of layers that the floor covering includes, the yield of the heating function can be greatly reduced. The floor covering layers can thushave a barrier effect and limit the passage of heat from the heating sublayer to the room to be heated.

Another disadvantage of these recessed heating sublayers is that for the most part they incorporate a network of resistive electrodes or water circulation channels distributed unequally under the surface to be heated, thus resulting in an inhomogeneous distribution of heat dissipation in the room. Additionally, they can be quite thick, in particular over 1 mm, making it impossible to incorporate them among the layers of a multilayer structure for the production of a floor covering keeping adequate flexibility properties.

Also known are multilayer structures for producing heating floors comprising a heating layer interposed between the surface layer and the back sublayer of said multilayer structures, said heating layer being made from an electrode network. These multilayer structures however have the same problems of inhomogeneous distribution of heating in the room, because the electrode network needs to be widely ramified in order to heat the entire surface. The electrode network thus generally comprises a conductor making numerous loops under the surface to be heated. Because of that, the design of these multilayer structures makes it difficult or even impossible to drill into the heating layer without risk of cutting an electrode and thereby separating a portion of the electrode network from the electric power supply. Drilling operations can in particular be necessary before installing in order to go around an obstacle on the support such as piping or even after installing to allow a duct or cable to pass through the floor covering. These multilayer structures thus make cutting or drilling of the coating complex during or after the installation operation. Additionally, the production of the electrode network is complex and costly in conducting material, because it is mostly implemented of copper or aluminum.

### SUMMARY OF THE DISCLOSURE

One of the purposes of the presently described embodiments is therefore to remedy the aforementioned disadvantages by proposing a multilayer structure resistant to traffic and indentation for the production a heating floor or wall covering or the like whose installation, repair and renovation are easy, maintains adequate properties of flexibility to facilitate its format, for example in rolls, and installation, which has good heating performance and the heating of which is distributed homogeneously over said coating, which is inexpensive to implement, and the drilling and cutting of which are facilitated.

Another objective of the presently described embodiments is to provide such a multilayer structure which has mechanical properties serving to keep an installation operation comparable to conventional operations for installing rolled band, panel, slab, strip or similar. This is in particular in order to use the multilayer structure for renovation of housing or rooms, without involving major operations or generating construction debris.

For this purpose, a multilayer structure is proposed for producing a heating floor or wall covering or similar, conforming to that of the state-of-the-art in that it comprises an upper decorative layer comprised of at least one surface layer of plastic material, said decorative layer being bonded onto a heating layer, said heating layer being bonded onto a lower sublayer intended to be installed on the floor or a wall or the like.

The heating layer comprises a conductive band comprising conductive particles homogeneously distributed over the surface and/or in the thickness of said conductive band, said conductive band supporting at least three conductive electrodes, and said conductive electrodes being spaced from one another and configured so as to define a discontinuous heating surface.

In general, but without limitation, the electrodes extend substantially along a longitudinal direction and are disposed parallel to each other.

According to one embodiment, the electrodes are spaced from one another and disposed parallel to each other so as to obtain a central electrode disposed between two lateral electrodes. For example, the central electrode is disposed substantially in the center of the conducting band and equidistant from two lateral electrodes.

To obtain a heating surface, the electrodes are configured so as to have an electric potential difference and to obtain electric current circulation between at least two electrodes. For example, an electric potential is applied to the central electrode and at least one different electric potential is applied to each of the lateral electrodes, so as to obtain a current circulation between the center electrode and each of the two lateral electrodes. Said circulation can in particular be obtained with direct or alternating current.

The resulting multilayer structure in particular allows a homogeneous distribution of the heating when an electric current passes through at least one part of the conductive band of said heating layer. By applying an electric voltage, resulting from a potential difference, between two conductive electrodes, the resistance of the conductive band disposed between said two electrodes produces a release of heat by resistive heating over the entire heating surface between the electrodes. The heat is then transmitted to the other layers of the multilayer support, in particular the decorative layer, and then to the room in which the structure is installed, thus enabling the heating of the room.

The conductive band comprises conductive particles distributed homogeneously over the surface and/or in the thickness of said conductive band; it can thus be partially cut or pierced without risking electrically isolating one part of the conductive band from another. The resulting heating surface is considered as discontinuous to the extent where no heating is produced over the width of the conductive band supporting the conductive electrodes. The electrodes are thus advantageously chosen with very narrow width, more advantageously in the form of conductive ribbons. As an example, good results are obtained with electrodes in the form of conductive ribbons with a width of between several millimeters and several centimeters wide, preferably between 5 mm and 10 cm wide, more preferably between 5 mm and 3.5 cm wide. The thickness of the conductive electrodes is generally less than 100 μm.

Generally, the central electrode will have a width greater than the width of the lateral electrodes so as to reduce the resistance thereof by increasing the cross section thereof.

The result is a multilayer heating structure that can be installed in crowded rooms or rooms having obstacles requiring cutting operations. In fact, depending on the location of an obstacle in the room, it may be necessary to cut a part of the multilayer structure. By doing this cutting, a part of the heating layer may be made unusable, for example because of cutting one of the conductive electrodes supported by the conductive band. Insofar as this cutting leaves a part of the conductive band disposed between two conductive electrodes, it is possible to heat the room in which the multilayer structure is installed by supplying power to the remaining conductive electrodes.

The use of a conductive band supporting at least three electrodes disposed side-by-side and spaced from one another also makes it possible to obtain multilayer coverings of any width, for example a width greater than 1 m, advantageously between 1 m and 5 m, without changing the time for the operation of installing the wall or floor covering. Additionally, the fabrication of this type of covering is made easier in so far as the heating layer can be bonded in one pass, for example by lamination, to the conductive electrodes and to the decorative layer and/or to the sublayer.

Advantageously, the conductive band supports at least two pairs of conductive electrodes, said electrodes being spaced apart and configured so as to define a discontinuous heating surface. This embodiment is particularly advantageous because it generally allows using pairs of electrodes of identical width, therefore simplifying the production process of the multilayer structure and reducing the cost thereof.

In general, but without limitation, at least two pairs of electrodes extend substantially along a longitudinal direction and are disposed parallel to each other. An electrode pair is comprised of two electrodes spaced from one another solely by the conductive band such that electric potential difference applied to this electrode pair produces an electric current flow in a single part of the conductive band. Two electrodes from an electrode pair are generally spaced from one another by a distance greater than 5 cm, advantageously between 5 cm and 60 cm. Two electrode pairs are generally spaced from one another by a distance between the closest two electrodes of each pair of less than 5 cm, preferably between 0.5 and 3 cm.

For a heating surface, each pair of electrodes has an electric potential difference. For example, an electric potential is applied to one of the electrodes of a pair and at least one different electric potential is applied to the other electrode of the same pair, so as to obtain current flow between the electrodes. Said circulation can in particular be obtained with direct or alternating current. The resulting heating surface is considered as discontinuous to the extent where no heating is produced over the width of the conductive band supporting the conductive electrodes. Similarly, if a single electric potential is applied to the two closest electrodes of each pair, no heating is obtained over the width of the conductive band disposed between the electrode pairs. The electrodes are thus advantageously chosen with very narrow width, more advantageously in the form of conductive ribbons.

Advantageously, the heating layer comprises at least two conductive bands disposed side-by-side and spaced from one another, said conductive bands comprising conductive particles distributed homogeneously over the surface and/or in the thickness of said conductive bands, each conductive band supporting two conductive electrodes spaced from one another so as to define a discontinuous heating surface.

In this way, the resulting multilayer structure allows in particular a homogeneous distribution of heating when an electric current passes through the two conductive bands of said heating layer. By applying an electric voltage between the two conductive electrodes supported by each conductive band, the resistance of each conductive band releases heat through resistive heating distributed over the entire heating surface between the electrodes. The heat is then transmitted to the other layers of the multilayer support, in particular the decorative layer, and then to the room in which the structure is installed, thus enabling the heating of the room. Since these conductive bands comprise conductive particles distributed homogeneously over the surface and/or in the thickness of said conductive bands, they can be partially cut or pierced without risk of electrically isolating one part of the conductive band from another. The resulting heating surface is considered discontinuous in so far as each conductive band is independent and has its own electrode pair. An electric current can thus pass through one conductive band without the other band being in operation.

Advantageously, the heating layer of the multilayer structure thus comprises at least two conductive bands disposed side-by-side and spaced from one another. In this way, a multilayer heating structure can be obtained that can be placed in crowded rooms or rooms having obstacles requiring cutting operations. In fact, depending on the location of an obstacle in the room, it may be necessary to cut a part of the multilayer structure. By doing this cutting, a part of the heating layer may be made unusable, for example because of cutting one conductive band or one of the conductive electrodes supported by one of the two conductive bands. However, because of the presence of a second conductive band, it is then still possible to heat the room in which the multilayer structure is placed by supplying power to the conductive electrodes supported by this second conductive band. Additionally, depending on the resistivity of the conductive band, it may be difficult to obtain distances between two electrodes supported by a single conductive band greater than 1 m, even greater than 50 cm, while keeping voltage supply values that do not endanger the occupants of the room in which the multilayer structure is located. The voltage value necessary to achieve conventional heating power, on the order of 100 W/m² of surface of said band, is directly proportional to the distance between two electrodes supported by a single conductive band. Because of this, the use of at least two conductive bands disposed side-by-side and spaced from one another also makes it possible to obtain multilayer coverings of conventional width, for example a width greater than 1 m, advantageously between 1 m and 5 m, without changing the time required for the installation of the wall or floor covering.

The conductive bands comprise conductive particles distributed homogeneously over the surface and/or in the thickness of said conductive bands. A conductive band can in particular be made from a nonwoven textile and/or plastic comprising conductive particles distributed homogeneously at the surface and/or in the thickness of the band. As an example, a conductive band can be made from a nonwoven textile impregnated, coated or powdered with conductive particles. The conductive band can for example be made from plastic, in particular PVC, acrylic or polyolefin, comprising conductive particles such as carbon black, in sufficient quantity for the resulting band to be conductive. A conductive band can also be achieved by applying a paint comprising conductive particles, in sufficient quantity for the resulting band to be conductive, to the surface of a band made from plastic.

Conductive is preferably understood to mean a resistivity value measured from one edge of a conductive band to the other in the transverse direction, or between two electrodes supported by a single conductive band less than 100 ohms/m, preferably less than 10 ohms/m, more preferably less than 5 ohms/m, and still more preferably between 1 ohms/m and 5 ohms/m. With such resistivity values, heating powers on the order of several hundred watts per square meter of coating can be obtained for supply voltages at the electrodes that do not endanger occupants of the rooms where the multilayer structures are installed. Recommended supply voltages are in particular voltages in the very low voltage domain, being less than 110 Vdc. Preferably, the supply voltages for the electrodes are below 60 Vdc or even below 36 Vdc. AC voltage sources could also be used.

Advantageously, in the case where the multilayer structure comprises at least two conductive bands, the electrodes are disposed along the longitudinal edges of the conductive bands. In particular, the heating surface can be optimized this way in order for it to extend over almost the entirety of the surface of the multilayer structure thus formed. The heating surface produced this way extends longitudinally and between the electrodes supported by each conductive band.

Advantageously, the multilayer structure is produced in the form of a band where the one or more conductive bands extend along said band. This type of structure can also be made by a continuous process, in which the one or more conductive bands are for example unwound and then continually bonded onto the decorative layer and the sublayer as these advance in said continuous process. The direction of progress of the process corresponds to the longitudinal direction of the band thus formed. Thus the described embodiments allow a multilayer structure to be obtained which can be manufactured and transported in roll form.

Alternatively, the multilayer structure is made in the form of a band where the one or more conductive bands extend transversely to said band.

The conductive particles that the conductive bands comprise can be carbon black particles, drops of conductive ink such as silver or carbon ink, carbon nanotubes, carbon fibers or equivalent.

A conductive band made from a nonwoven textile can be made from glass fibers but also from synthetic polymers such as polyester, polyamide or polypropylene fibers. As an example, it is possible to impregnate, coat or powder the nonwoven textile with conductive particles such as carbon particles or equivalent. In particular, a conductive band can be made from a nonwoven textile impregnated with carbon fibers, silver ink or even carbon ink. A conductive band made of an impregnated nonwoven textile is advantageous because it is a particularly homogeneous conductor throughout the thickness of the band, since the conductive particles are themselves distributed homogeneously during production of said conductive band.

A conductive band made of a nonwoven textile can also be partially cut or pierced without risking electrically isolating one part of the conductive band from another. It can also be easily handled in conventional continuous methods for fabrication of multilayer structures for producing floor or wall coverings, in particular in roll form.

Nonwoven textiles which can be used advantageously have a grammage of between 25 g/m² and 80 g/m², advantageously between 25 g/m² and 40 g/m². With such a grammage it is in particular possible to obtain nonwoven textiles which can be disposed between the layers of a multilayer structure while retaining good properties of bonding with a decorative layer and the sublayer made of thermoplastic material. A conductive band made of a nonwoven textile can thus easily be heat-laminated or bonded with the sublayer and a decorative layer made of plastic in a conventional floor covering fabrication method. The impregnation by heat lamination of decorative layers, the sublayer and possible adhesives is sufficiently deep in the thickness of conductive bands made of a nonwoven textile that it does not lead to a risk of delamination.

Advantageously, each conductive band made of a nonwoven textile can be used as coating support in a fabrication method for the multilayer structure. For example, a conductive band made of a nonwoven textile can be coated with PVC or acrylic or polyolefin Plastisol and then gelified in order to obtain the decorative layer or the sublayer of the multilayer structure.

Advantageously, in the case where the multilayer structure comprises at least two conductive bands, the two conductive bands made of a nonwoven textile are disposed side-by-side and spaced from one another and then laminated in order to be arranged in contact with a single reinforcement work such as a glass fiber mat and/or a glass grid, in order to obtain a strengthened coating support resistant to strong pulling forces. In this way, a PVC or acrylic or polyolefin Plastisol can be coated onto the resulting reinforced coating support and then gelified in order to obtain the decorative layer or sublayer of the multilayer structure.

The decorative and sublayer layers are for example obtained conventionally by coating, pressing, extrusion or calendaring and from plastics such as PVC, acrylics, polyurethanes, polyolefins and mixtures thereof with which to obtain a smooth and flat surface.

The two electrodes supported by a single conductive band are spaced from one another in order to avoid their contact and can be supported on the same surface, opposite the decorative layer or opposite the sublayer of said band or else supported by two opposite surfaces of said band.

Advantageously, the electrodes are conductive ribbons, made of copper or aluminum for example. In particular, very thin electrodes can be obtained in this way, specifically thinner than 100 μm, thus limiting the well-known effect on the decorative layer called telegraphing. Telegraphing corresponds to the appearance of defects on the decorative layer of a floor covering in particular due to the presence of irregularities of the support disposed under the covering, such as clumps of adhesive or small rough places. This effect can also be observed when the structure of the covering includes a reinforcing grid. This effect is not necessarily visible during production but can appear after installation, or even after several months of use.

The electrodes can in particular be made in a copper or aluminum strap by cutting ribbons with a width narrower than 5 cm, advantageously between 0.5 cm and 3.5 cm. Said ribbons are then bonded onto each conductive band using a conductive adhesive.

Advantageously, the heating layer comprises a dielectric layer bonded onto the decorative layer and/or a dielectric layer bonded onto the sublayer. A dielectric layer can be bonded, for example by thermal bonding, onto the upper surface of the heating layer, i.e. the surface opposite the decorative layer, or onto the lower surface of the heating layer, i.e. the surface opposite the sublayer. For example, it is possible to thermally bond a film obtained from polyvinyl chloride (PVC) onto the upper and lower surfaces of the heating layer in order to obtain a sufficiently solid assembly for handling during conventional production line methods, in particular methods for laminating multilayer structures of thermoplastic material such as PVC. A dielectric layer can also be obtained from polyethylene (PE), polyethylene terephthalate (PET) or any other nonconductive polymer.

Conventionally, the heating layer can be bonded by adhering, thermal bonding, hot bonding (known as hot melt) and cold bonding onto the sublayer and the decorative layer.

Within the presently described embodiments, conventional installation techniques do not need to be modified since the mechanical behavior during installation of the multilayer structure with or without heating layer is comparable.

The advantage of the presently described embodiments is also to propose a multilayer structure that is thin, specifically less than 3 mm, and lower in cost than conventional techniques with which to provide a local heating function, in particular by the floor or walls.

The presently described embodiments can also be used for deicing applications for exterior paving. Other applications are also conceivable. In particular, in the case where the decorative layer includes thermochromic pigments, it is possible to make multilayer signaling structures. Indeed, heating the multilayer structure by the heating layer causes the thermochromic pigments to change color and in that way display a message or logo particularly homogeneously.

With the presently described embodiments, a heating solution for a room can be provided without needing extensive work. In the case where the multilayer structure is made in roll form, the installation consists of unrolling the roll on a clean support and connecting the electrodes to a direct or alternating current power source. Additionally, with the presently described embodiments the multilayer heating structure is easily adapted to the constraints of the room, such as the presence of conduits, drains or attachment points that require cutting the floor or wall covering.

In this way, the room can be renovated more quickly and with a very short unavailability while providing functions of heating and protection of the floors and/or walls. The cost of the renovation is greatly reduced with this configuration.

Advantageously, the sublayer of the multilayer structure is a foam, for example obtained from a mixture of expanded polyvinyl chloride, plasticizer and filler. The presence of air trapped in the foam serves in particular to improve the thermal insulation and increase heat transmission from the heating layer to the decorative layer and therefore into the room.

Alternatively, the sublayer is a compact sublayer, meaning that it does not comprise bubbles, for example obtained from polyvinyl chloride, plasticizer and filler. With a compact sublayer, the resulting multilayer structure can have a better resistance to indentation.

Preferably, and in order to improve the mechanical performance and resistance to indentation and rolling and to provide dimensional stability of the floor covering over time, the decorative layer and/or the sublayer comprise a textile reinforcement, such as a fiberglass grid or mat.

In order to heat the room in which the multilayer structure is located, each electrode is connected to a direct or alternating current source through a connector. The connection between the connectors and the electrodes can be done by any means which could establish and maintain electrical contact. As an example, a connector can in particular pass through the thickness of the multilayer structure opposite an electrode and be held by clipping, screwing or equivalent. Advantageously, the current supply for each connector can be switched off by a command-control system, in order to be able to activate or deactivate certain heating surfaces, in particular in case of moving partitions in the rooms. Advantageously, the current supply for each connector can be modified by a command-control system in order to be able to increase or decrease the temperature of certain heating surfaces.

The presently described embodiments also relate to a process for continuous production of a multilayer structure according to the presently described embodiments comprising the following steps:
Obtaining a conductive band made of a nonwoven textile, for example by impregnation with conductive particles;
Bonding to the conductive band, for example by bonding using a conductive adhesive, at least three electrodes spaced from one another and configured so as to define a discontinuous heating surface;
Laminating the conductive band on a reinforcement such as a fiberglass mat and/or a fiberglass grid in order to obtain a reinforced coating support;
Coating a Plastisol on the reinforced coating support in order to obtain a decorative layer or a sublayer;
Thermal bonding, coating, bonding or pressing a decorative layer or as applicable a sublayer made of plastic on the back of the structure resulting from the previous step.

The presently described embodiments also relate to a process for continuous production of a variant of a multilayer structure according to the presently described embodiments comprising the following steps:
Obtaining two conductive bands made of a nonwoven textile, for example by impregnation with conductive particles;
Bonding, using conductive adhesive, two electrodes spaced from one another along the longitudinal edges of each conductive band;
Laminating side-by-side and spaced from one another the two conductive bands such as obtained in the previous step, either arranged in contact on reinforcement such as a glass fiber mat and/or a fiberglass grid in order to obtain a reinforced coating support;
Coating a Plastisol onto the coating support resulting from the previous step in order to get a decorative layer or a sublayer;
Thermal bonding, coating, bonding or pressing a decorative layer or as applicable a sublayer made of plastic onto the back of the structure resulting from the previous step.

### BRIEF DESCRIPTION OF THE FIGURES

Further advantages and features will become clearer from the following description, given by way of a non-limiting example, of the multilayer structure for the implementation of a heating floor or wall coating from the accompanying drawings in which:

FIG. 1 shows the multilayer structure schematically and in transverse cross section;

FIG. 2 shows an embodiment schematically and in top view;

FIG. 3 shows an alternative multilayer structure schematically and in transverse cross section;

FIG. 4 shows an alternative implementation of the multilayer structure schematically and in top view.

FIG. 5 shows a multilayer structure schematically and in transverse cross section;

FIG. 6 shows an embodiment schematically and in top view;

FIG. 7 shows a multilayer structure installed in an crowded room;

FIG. 8 shows an alternative implementation of the multilayer structure.

### DETAILED DESCRIPTION

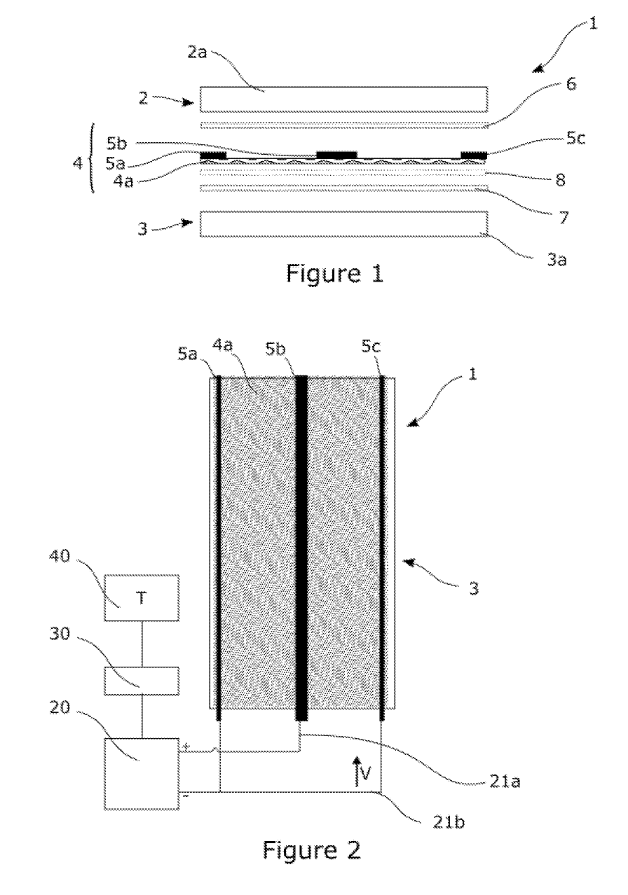

With reference to FIG. 1, the presently described embodiments relate to a multilayer structure (1) for implementing a heating floor or wall or similar covering, i.e. allowing the heating of the room in which the structure is installed.

The multilayer structure (1) can be made in panel, slab, band or roll form. The multilayer structure (1) is intended for the implementation of floor or wall covering installed bonded, semi-floating or floating, with high performance in terms of sealing and traffic resistance.

The multilayer structure (1) comprises an upper decorative layer (2) made up of at least one plastic surface layer (2a), bonded onto a heating layer (4), said heating layer (4) being bonded onto a lower sublayer (3) intended to be installed on the floor or a wall or the like. The heating layer includes a conductive band (4a) comprising conductive particles homogeneously distributed over the surface and/or in the thickness of said conductive band (4a), said conductive band (4a) supporting at least three conductive electrodes (5a, 5b, 5c), and said conductive electrodes being spaced from one another and configured so as to define a discontinuous heating surface.

The upper decorative layer (2) and the lower sublayer (3) can have diverse and varied compositions and structures depending on the application considered.

For that purpose, the decorative layer (2) comprises a surface layer (2a) made of polyvinyl chloride comprising a thickness of between 0.2 and 1 mm. Said surface layer (2a) can be colored in the mass and comprise decorative granules throughout the thickness thereof. Preferably, and for satisfying, for example, a U4 P3 rating under the French standard UPEC, the surface layer (2a) comprises a density of between 1.4 and 1.6, a residual dent of less than 0.10 mm and 25,000 cycle chair caster resistance. The surface layer (2a) can be transparent and combined with a printed decorative layer (not shown) on the back surface thereof, specifically on the surface thereof opposite the heating layer (4). The decorative imprinted layer generally comprises a thickness of between 0.07 and 0.5 mm.

The decorative layer (2) is bonded for example by hot lamination or by means of an adhesive layer (not shown) to the heating layer (4). The heating layer (4) comprises a conductive band (4a), produced for example from a nonwoven textile impregnated with conductive particles, specifically fiberglass impregnated with carbon fibers, with a grammage of between 25 g/m² and 80 g/m², advantageously between 25 g/m² and 40 g/m². A conductive band produced from a nonwoven fiberglass textile impregnated with carbon fibers with a grammage of 30 g/m² has a resistance of between 4 and 5 ohms over a distance of 40 cm.

The conductive band (4a) supports at least three conductive electrodes (5a, 5b, 5c) spaced from one another so as to define a discontinuous heating surface. The heating surface thus extends between each electrode supported by a conductive band. Obviously, the grammage of the nonwoven textile of the conductive band and the quantity of conductive particles could be adjusted to obtain the desired resistivity value depending on the size of the heating surface.

The conductive electrodes (5a, 5b, 5c) are ribbons disposed in the center and along the longitudinal edges of the conductive band (4a) such that the heating surface extends over almost all of the surface of the multilayer structure thus formed. The resulting heating surface extends between the electrodes (5a, 5b) and (5b, 5c). In the case of a structure (1) produced in the shape of a band, the heating surface extends in the longitudinal direction of the band thus produced and between the electrodes (5a, 5b) and (5b, 5c).

The electrodes (5a, 5b, 5c) are for example ribbons made of a 40 μm thick copper strap. The electrodes (5a, 5b, 5c) are for example bonded onto each conductive band by a 25 μm thick layer of conductive adhesive.

Advantageously the heating layer (4) comprises a dielectric layer (6) bonded onto the decorative layer (2).

Advantageously the heating layer (4) comprises a dielectric layer (7) bonded onto the sublayer (3).

As it relates to the lower sublayer (3), it comprises a balancing layer (3a) of plastic, such as polyvinyl chloride, preferably comprising a thickness of 2 mm. Preferably, and in order to satisfy for example the French UPEC standard classification U4 P3, the balancing sheet (3a) has a Shore hardness A of between 80 and 95. Said balancing layer (3a) can also be a PVC or polyurethane foam in order to confer acoustic and/or thermal insulation properties to the floor or wall covering. In the case where said balancing layer (3a) is foam, the density thereof is between 0.2 and 0.9.

Said balancing layer (3a) is next bonded, by hot lamination for example, onto the heating layer (4).

A textile reinforcement (not shown) can also be embedded in the sublayer (3) and/or the decorative layer (2). Said reinforcement has for example the form of a grid or screen of textile yarns of negligible thickness, or even a fiberglass mat. The textile yarns of said reinforcement are, preferably, spaced from one another by 3 mm along the longitudinal and transverse dimensions and have a linear mass density of between 20 g/m and 70 g/m, advantageously between 35 g/m and 50 g/m. A reinforcement enables the mechanical performance and resistance of the floor or wall coating to indentation and rolling to be increased. The reinforcement also provides dimensional stability of the covering over time.

The arrangement of the decorative layer (2) and the sublayer (3) are given as nonlimiting examples. It is obvious that depending on the application considered, layers can be added to or removed from the multilayer structure (1) described.

As an example, the multilayer structure (1) described below is intended to be used for example in hospitals or in a school environment. The multilayer structure (1) has good mechanical performance in terms of resistance to indentation and rolling and incorporates heating functions.

In the case where the conductive band (4a) is made of a nonwoven textile, the conductive band can be used as coating support in a fabrication method for the multilayer structure. For this purpose, the conductive band is laminated with a reinforcement (8), such as a fiberglass mat and/or fiberglass grid. In this way a reinforced coating support can be obtained. The width of the reinforcement (8) is advantageously greater than the width of the conductive band (4a). The electrodes (5a, 5b, 5c) are spaced from one another and then bonded onto the conductive band (4a). Alternatively, the electrodes (5a, 5b, 5c) are spaced from one another and then laminated on the reinforcement (8).

In this way, a PVC or acrylic or polyolefin Plastisol can be coated onto the resulting reinforced coating support and then gelified in order to obtain the decorative layer or sublayer of the multilayer structure.

A fiberglass grid can have the form of a grid or screen of textile yarns of negligible thickness, preferably, spaced from one another by 3 mm along the longitudinal and transverse dimensions and have a linear mass density of between 20 g/m and 70 g/m, advantageously between 35 g/m and 50 g/m.

With reference to FIG. 2, the presently described embodiments also relate to a multilayer structure (1) produced in the shape of a band, for the production of a heating floor or wall covering or similar, comprising a decorative layer (not shown), a heating layer and a lower sublayer (3) the heating layer (4) of which comprises a conductive band (4a) produced from a nonwoven textile comprising conductive particles homogeneously distributed on the surface and/or in the thickness of said conductive band (4a). The multilayer structure (1) is made in the form of a band and the conductive band (4a) extends along said band. The conductive band (4a) supports three conductive electrodes, respectively (5a, 5b, 5c), spaced from one another and configured so as to define a discontinuous heating surface. The heating surface thus extends over almost all of the surface, in the longitudinal and transverse directions, of the multilayer structure (1) thus formed.

In this way, a large size multilayer structure can be obtained while also limiting heating losses due to an excessive separation between the electrodes supported by the conductive band.

In order to heat the room in which the multilayer structure (1) is located, each electrode is connected to a direct or alternating current source (20) through two connectors (21a, 21b). The connection between the connectors and the electrodes can be done by any means which could establish and maintain electrical contact. As an example, a connector can in particular pass through the thickness of the multilayer structure opposite an electrode and be held by clipping, screwing or equivalent. Advantageously, a portion of the multilayer structure is disposed along an equipment duct or baseboard so as to mask the connectors in the equipment duct or the baseboard and protect them.

The resulting heating surface is considered as discontinuous to the extent where no heating is produced over the width of the conductive band supporting the conductive electrodes, in particular the electrode (5b). The electrodes are thus advantageously chosen with very narrow width, more advantageously in the form of conductive ribbons. Generally, the electrode (5b) will have a width greater than the width of electrodes (5a, 5c) so as to reduce the resistance thereof by increasing the cross section thereof. The electrode (5b) can be considered as a central electrode in so far as it is disposed between the electrodes (5a, 5c). The electrodes (5a, 5c) can be considered as lateral electrodes. In the example shown in FIG. 2, a positive electric potential is applied to the electrode (5b) and a negative potential is applied to the electrodes (5a, 5c). The current then flows in the parts of the conductive band (4a) disposed between the electrodes (5a, 5b) and (5b, Sc).

In order to achieve a regulated heating system, the direct-current source (20) can be controlled by a regulation system (30) connected to a temperature probe (40) disposed in the room to be heated or linked to the decorative layer or sublayer of the multilayer structure (1).

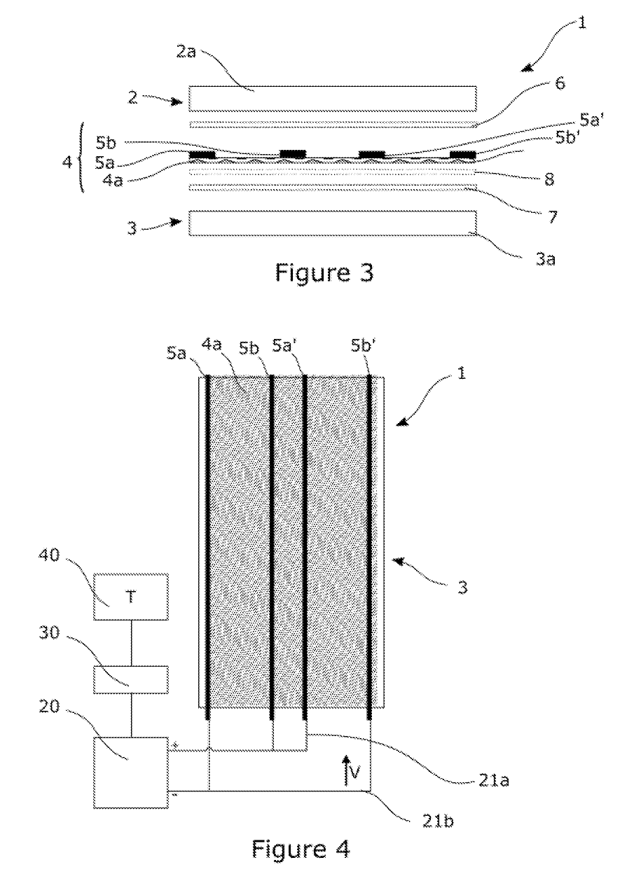

With reference to FIG. 3, a variant of embodiment of the multilayer structure (1) comprises a conductive band (4a) supporting at least two pairs of conductive electrodes (5a, 5b, 5a′, 5b′), said electrodes being spaced from one another and configured so as to define a discontinuous heating surface.

With reference to FIG. 4, the presently described embodiments also relate to a multilayer structure (1) according to FIG. 3 implemented in the shape of a band, for the production of a heating floor or wall covering or similar, comprising a decorative layer (not shown), a heating layer and a lower sublayer (3) the heating layer (4) of which comprises a conductive band (4a) produced from a nonwoven textile comprising conductive particles homogeneously distributed over the surface and/or in the thickness of said conductive band (4a). The multilayer structure (1) is made in the form of a band and the conductive band (4a) extends along said band. The conductive band (4a) supports two pairs of conductive electrodes (5a, 5b, 5a′, 5b′) spaced from one another and configured so as to define a discontinuous heating surface. The heating surface thus extends over almost all of the surface, in the longitudinal and transverse directions, of the multilayer structure (1) thus formed. The resulting heating surface is considered as discontinuous to the extent no heating is produced over the width of the conductive band supporting the conductive electrodes (5a, 5b, 5a′, 5b′). Similarly, if the same electric potential is applied to the two closest electrodes of each pair (5b, 5a′), no heating is obtained over the width of the conductive band disposed between the electrodes (5b, 5a′). The electrodes are thus advantageously chosen with very narrow width, more advantageously in the form of conductive ribbons.

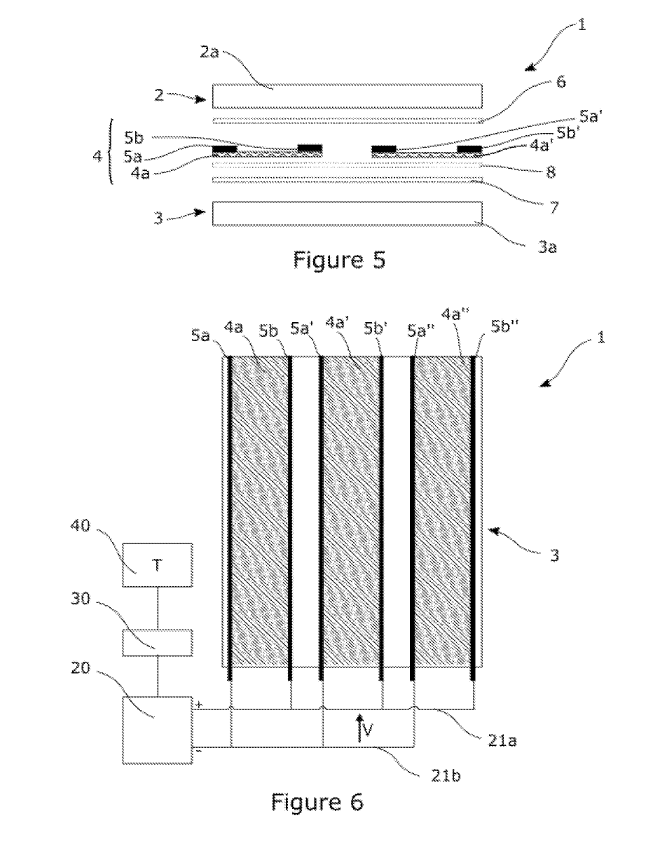

With reference to FIG. 5, the presently described embodiments also relate to an alternative embodiment of the multilayer structure (1).

The multilayer structure (1) comprises an upper decorative layer (2) made up of at least one plastic surface layer (2a), bonded onto a heating layer (4), said heating layer (4) being bonded onto a lower sublayer (3) intended to be installed on the floor or a wall or the like. The heating layer is comprised of at least two conductive bands (4a, 4a′) disposed side-by-side and spaced from one another, said conductive bands (4a, 4a′) comprising conductive particles distributed homogeneously over the surface and/or in the thickness of said conductive bands (4a, 4a′), and each conductive band (4a, 4a′) supports two conductive electrodes (5a, 5b, 5a′, 5b′) spaced from one another so as to define a discontinuous heating surface.

The heating layer (4) is made up of two conductive bands (4a, 4a′) disposed side-by-side and spaced from one another. The conductive bands (4a, 4a′) are produced for example from a nonwoven textile impregnated with conductive particles, specifically fiberglass impregnated with carbon fibers, with a grammage of between 25 g/m² and 80 g/m², advantageously between 25 g/m² and 40 g/m². A conductive band produced from a nonwoven fiberglass textile impregnated with carbon fibers with a grammage of 30 g/m² has a resistance of between 4 and 5 ohms over a distance of 40 cm.

Each conductive band (4a, 4a′) supports two conductive electrodes (5a, 5b, 5a′, 5b′) spaced from one another so as to define a discontinuous heating surface. The heating surface thus extends between each pair of electrodes supported by a single conductive band. Obviously, the grammage of the nonwoven textile of the conductive band and the quantity of conductive particles could be adjusted to obtain the desired resistivity value depending on the size of the heating surface.

The conductive electrodes (5a, 5b), (5a′, 5b′) are ribbons disposed along the longitudinal edges of the conductive bands (4a, 4b, 4a′, 4b′) such that the heating surface extends over almost all of the surface of the multilayer structure thus formed. The resulting heating surface extends between the electrodes (5a, 5b) and (5a′, 5b′). In the case of a structure (1) produced in the shape of a band, the heating surface extends in the longitudinal direction of the band thus produced and between the electrodes (5a, 5b) and (5a′, 5b′).

Alternatively, the electrodes (5b) and (5a′) are in electrical contact and are obtained for example from a single conductive ribbon. In this scenario, the electrical connections of the electrodes (5a) and (5b′) are then modified in order to keep two conductive bands (4a, 4a′) powered independently. A discontinuous heating surface with simpler implementation is defined by this configuration. The single electrode corresponding to electrodes (5b) and (5a′) is for example supplied with 24 Vdc and the electrodes (5a) and (5b′) are connected to ground.

The electrodes (5a, 5b, 5a′, 5b′) are for example ribbons made of a 40 μm thick copper strap. The electrodes (5a, 5b, 5a′, 5b′) are for example bonded onto each conductive band by a 25 μm thick layer of conductive adhesive.

In the case where each conductive band (4a, 4a′) is made of a nonwoven textile, said conductive bands can be used as a coating support in a fabrication method for the multilayer structure. For this purpose, each conductive band produced from a nonwoven textile (4a, 4a′) is disposed edge-to-edge and spaced from one another and then laminated in order to be arranged in contact with a single reinforcement (8), such as a fiberglass mat and/or a fiberglass grid. In this way a reinforced coating support can be obtained. The width of the reinforcement (8) is advantageously larger than the sum of the widths of the conductive bands disposed edge-to-edge in order to laminate the conductive bands over their entire width on the reinforcement. The electrodes (5a, 5b, 5a′, 5b′) are spaced from one another and then glued onto the conductive band (4a, 4a′). Alternatively the electrodes (5a, 5b, 5a′, 5b′) are spaced from one another and then bonded onto the reinforcement (8), then each conductive band (4a, 4a′) is disposed edge-to-edge and spaced from one another and then complexed onto the electrodes and the reinforcement (8).

In this way, a PVC or acrylic or polyolefin Plastisol can be coated onto the resulting reinforced coating support and then gelified in order to obtain the decorative layer or sublayer of the multilayer structure.

With reference to FIG. 6, the presently described embodiments also relate to a multilayer structure (1) produced in the shape of a band, for the production of a heating floor or wall covering or similar, comprising a decorative layer (not shown), a heating layer and a lower sublayer (3) the heating layer (4) of which comprises three conductive bands (4a, 4a′, 4a″) produced in a nonwoven textile comprising conductive particles homogeneously distributed over the surface and/or in the thickness of said conductive band (4a, 4a′, 4a″). The conductive bands (4a, 4a′, 4a″) are disposed side-by-side and spaced from one another. The multilayer structure (1) is made in the form of a band and the conductive bands (4a, 4a′, 4a″) extend along said band. Each conductive band (4a, 4a′, 4a″) supports two conductive electrodes (5a, 5b), (5a′, 5b′) and (5a″, 5b″) spaced from one another so as to define a discontinuous heating surface. The heating surface thus extends over almost all of the surface, in the longitudinal and transverse directions, of the multilayer structure (1) thus formed.

In this way, a very wide multilayer structure, preferably over 1.20 m, can be obtained while also limiting heating losses due to an excessive separation between the electrodes supported by a single conductive band. In fact, it is undesirable to have the distance between two conductive electrodes of a single conductive band greater than 50 cm, since the current necessary to heat said conductive band is directly proportional to the separation and quickly reaches dangerous electrical powers in inhabited rooms.

Still according to FIG. 6, a multilayer structure (1) is produced for example in the form of a band about 1.20 m wide comprising three conductive bands (4a, 4a′, 4a″) made of a nonwoven textile with a grammage of 30 g/m² with fiberglass impregnated with carbon fibers, with each band measuring 40 cm wide. The bands are disposed side by side and spaced from one another in order to obtain a heating surface about 1.20 m wide. Each conductive band supports two copper ribbons 1 cm wide and 45 μm thick, spaced from one another and glued onto the conductive band with a 25 μm layer of conductive adhesive. A few millimeters are left between the conductive electrodes (5b, 5a′) and (5b′, 5a″) in order to limit the risks of a short circuit.

For a conductive band made of a nonwoven textile, with a grammage of 30 g/m² of glass fibers impregnated with carbon fibers, 40 cm wide and 300 cm long, the measured resistance is between 4 and 5 ohms between two electrodes supported by a single conductive band. In that way, with a 24 Vdc source, a heating power of 109 W is obtained over the surface between two electrodes of a single conductive band over a width of 40 cm and a length of 300 cm. With a 36 V source, a 236 W heating power is obtained.

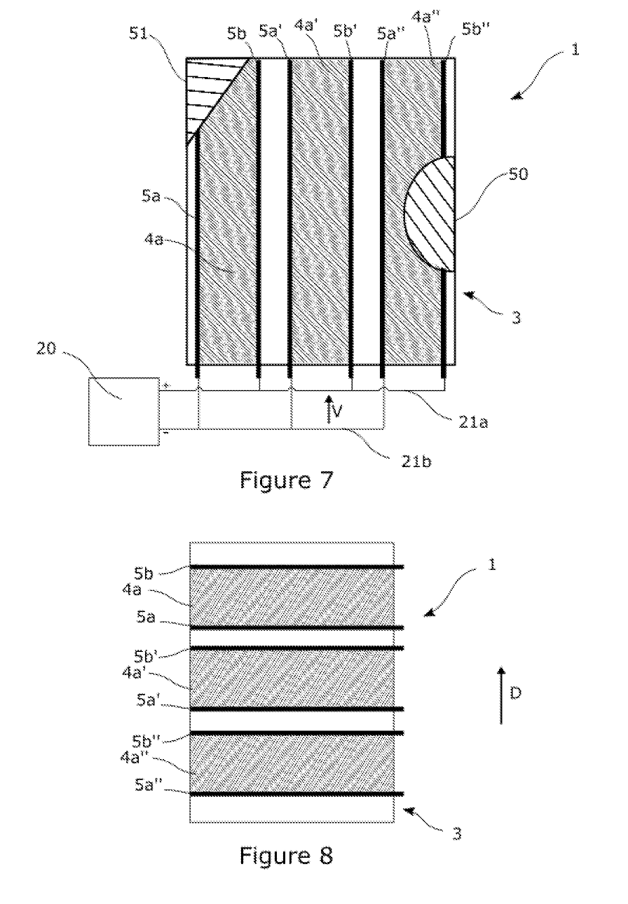

With reference to FIG. 7, the heating multilayer structure (1) according to FIG. 6 is shown schematically installed in crowded rooms with obstacles (50, 51) requiring cutting operations. In the example shown, it is necessary to cut a part of the multilayer structure in order to go around the obstacles (50, 51). By doing this cutting, a part of the heating layer is made unusable, for example because of cutting the electrode 5b″. It is, however, still possible to heat the room in which the multilayer structure is installed by supplying the conductive electrodes (5a′, 5b′) supported by the conductive band (4a′). The other conductive bands (4a, 4a″) could also be supplied by their own electrodes in order to heat the surfaces facing each of these electrodes (4a, 4a″); the resulting heating surface is however reduced.

With reference to FIG. 8, the presently described embodiments also relate to a multilayer structure (1) produced in the shape of a band, for the production of a heating floor or wall covering or similar, comprising a decorative layer (not shown), a heating layer and a lower sublayer (3) the heating layer of which comprises three conductive bands (4a, 4a′, 4a″) comprising conductive particles homogeneously distributed over the surface and/or in the thickness of said conductive band (4a, 4a′, 4a″). The conductive bands (4a, 4a′, 4a″) are disposed side-by-side and spaced from one another. The multilayer structure (1) is made in the form of a band and the conductive bands (4a, 4a′, 4a″) extend transversally to said band. Each conductive band (4a, 4a′, 4a″) supports two conductive electrodes (5a, 5b), (5a′, 5b′) and (5a″, 5b″) spaced from one another so as to define a discontinuous heating surface.

Preferably, and whatever the embodiment, the heating layer (4) comprises a dielectric layer (6) bonded onto the decorative layer (2) and a dielectric layer (7) bonded onto the sublayer (3) in order to electrically insulate this layer from the other layers of the multilayer structure. The conductive bands (4a, 4a′) and also the electrodes (5a, 5b, 5c, 5a′, 5b′, 5a″, 5b″) that they support are thus sandwiched between two dielectric layers (6, 7). A dielectric layer can in particular be obtained from a sheet of PVC, polyethylene terephthalate (PET) or any other nonconductive polymer and bonded by thermal bonding for example.

A dielectric layer can also serve as support for implementation of the heating layer. For this purpose, each conductive band, for example a conductive band produced from a nonwoven textile, is disposed edge-to-edge and spaced from one another and then cold laminated with a dielectric layer (7) serving as support. The electrodes are subsequently spaced from one another and then bonded onto each conductive band. Advantageously, a second dielectric layer (6) is bonded onto each conductive band so as to sandwich the two conductive bands, and the electrodes that they support, between the dielectric layers (6) and (7) and to obtain an assembly which can be directly laminated with a decorative layer and a sublayer.

Advantageously, and whatever the embodiment, the heating layer (4) may comprise a reinforcement (8) bonded onto the decorative layer (2) and/or bonded onto the sublayer (3) arranged in contact with the one or more conductive bands (4a, 4a′, 4a″). The mechanical performance of the floor or wall coating and its resistance to indentation and to rolling can in particular be increased by a reinforcement (8). The reinforcement also provides dimensional stability of the covering over time.

From the preceding it can be seen that the presently described embodiments provide a multilayer structure (1) for the production of a heating floor or wall covering or similar, installed bonded, semi-floating or floating, thus achieving high classification levels in terms of resistance to traffic and impermeability, while guaranteeing a quick, inexensive renovation of a room, without disruption and and which incorporates efficient heating functions.

1. A multilayer structure for the production of a heating floor or wall covering or similar, said multilayer structure comprising a decorative layer made up of at least one plastic surface layer, said decorative layer being bonded onto a heating layer, said heating layer being bonded onto a sublayer intended to be installed on the floor or a wall or the like, wherein the heating layer comprises a conductive band comprising conductive particles homogeneously distributed over the surface and/or in the thickness of said conductive band, said conductive band supporting at least three conductive electrodes, and said conductive electrodes being spaced from one another and configured so as to define a discontinuous heating surface.

2. A multilayer structure according to claim 1, wherein the conductive band, supports at least two pairs of conductive electrodes, said electrodes being spaced apart and configured so as to define a discontinuous heating surface.

3. A multilayer structure according to claim 1, wherein the heating layer comprises at least two conductive bands disposed side-by-side and spaced from one another, said conductive bands comprising conductive particles distributed homogeneously over the surface and/or in the thickness of said conductive bands, and each conductive band supporting two conductive electrodes with said electrodes being spaced from one another so as to define a discontinuous heating surface.

4. A multilayer structure according to claim 3, wherein the electrodes are disposed along the longitudinal edges of the conductive bands.

5. A multilayer structure according to claim 1, wherein the multilayer structure is made in the form of a band and the one or more conductive bands extend along said band.

6. A multilayer structure according to claim 1, wherein the multilayer structure is made in the form of a band and the one or more conductive bands extend transversely to said band.

7. A multilayer structure according to claim 1, wherein the electrodes are conductive ribbons.

8. A multilayer structure according to claim 1, wherein the thickness of the electrodes is less than 100 μm.

9. A multilayer structure according to claim 1, wherein the heating layer comprises a dielectric layer bonded onto the decorative layer and a dielectric layer bonded onto the sublayer.

10. A multilayer structure according to claim 1, wherein each conductive band is made of plastic.

11. A multilayer structure according to claim 1, wherein each conductive band is made of a nonwoven textile.

12. A multilayer structure according to claim 11, wherein the nonwoven textile has a grammage of between 25 g/m² and 80 g/m².

13. A multilayer structure according to claim 1, wherein the conductive particles that comprise the one or more conductive bands are carbon fibers.

14. A multilayer structure according to claim 1, wherein the heating layer comprises a reinforcement arranged in contact with the conductive bands.
